(19) United States
(12) Patent Application Publication
(10) Pub. No.: US 2009/0114008 A1
(43) Pub. Date: May 7, 2009

(54) Method and apparatus

(75) Inventor: Philippe Cravatte, Aberdeen (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Corpro Systems Limited

(21) Appl. No.: 12/290,598

(22) Filed: Oct. 31, 2008

(30) Foreign Application Priority Data
Nov. 2, 2007 (GB) 0721506.4

(51) Int. Cl. G01F 1/00; E21B 47/10; E21B 47/06

(52) U.S. Cl. 73/152.29; 73/152.39; 73/152.51

(57) ABSTRACT

A method for determining the flow characteristics of a geological formation; in a particular embodiment the method comprising the steps of: providing a container such as a core barrel within the formation; adding a portion of the formation, such as a core sample, into the container; and whilst the container remains in the formation, injecting fluid into the container such that a portion of the fluid flows through said portion of the formation and measuring the flow of the injected fluid to give information on the nature, such as permeability, of the core sample. In preferred embodiments fluid is received from the portion of the formation in the container to give more information on the core sample. Certain embodiments include packers to direct the flow of the fluids within the container. Such in situ measurements provide more accurate data on the reservoir characteristics, such as reservoir permeability.

### FIELD OF THE INVENTION

This invention relates to a method and apparatus for determining the flow characteristics of a geological formation particularly but not exclusively the permeability. The invention is especially but not exclusively useful to determine the efficiency of Enhanced Oil Recovery (EOR) processes.

### BACKGROUND TO THE INVENTION

EOR processes can be applied to increase the recovery of oil and gas from existing hydrocarbon containing geological formations. Typical injection schemes involve injecting chemicals, gas or water into the geological formation at one point in order to increase the flow of hydrocarbons at a recovery point. Prior to and following an EOR fluid injection scheme it is important to obtain data on the nature and flow characteristics, especially permeability, of the formation.

The flow characteristics of a geological formation with or without EOR are important factors in determining the recoverability of oil and gas. It is known to take a core sample of a formation, recover the sample to the surface and conduct tests on the sample along with its associated fluids to gain information on its flow properties, such as permeability, as well as a variety of other properties, such as inter alia oil and water content, porosity and density. These tests are generally known as core analysis. However recovering the core sample to the surface often affects its integrity and therefore the accuracy and reliability of the subsequent tests.

An alternative approach to determine permeability is to use wireline logging. In this technique, an electrically powered instrument continuously measures and records the physical properties of the adjacent rocks in the well. The permeability of the rock is indirectly established through correlations between permeability and other petrophysical properties. This indirect method of determining permeability requires difficult calibration and is unreliable compared to direct measurement.

### SUMMARY OF THE INVENTION

According to a first aspect of the present invention there is provided a method for determining the flow characteristics of a geological formation, the method comprising:

providing a container within the formation;

adding a portion of the formation to the container; and whilst the container remains in the formation:

injecting fluid into the container such that a portion of the fluid flows through said portion of the formation;

measuring the flow of the injected fluid.

The measured flow of the injected fluid can be recorded and/or transmitted to the surface and can be used to determine a flow characteristic, such as the permeability of the said portion of the formation.

Thus the invention can reliably obtain information on the flow characteristics, such as the permeability, of a geological formation without recovering the sample back to the surface and thus without risking compromise of the integrity of the sample. Moreover the method of the invention can provide information on the flow characteristics of the sample which can be more accurate than that obtained from wireline logging and by direct measurement on recovered core samples.

Measuring the flow of the injected fluid includes measuring the flow rate, the pressure and the volume of fluid.

For certain embodiments the pressure and/or the flow rate of the injected fluid can give sufficient information to measure said flow of the fluid and therefore a flow characteristic of the formation.

However in preferred embodiments, a portion of fluid is received from the container and one or more, preferably each, of the following parameters are measured: the volume, flow rate and pressure of the fluid received; especially compared to one or more, preferably each, of the following parameters: the volume, flow rate and pressure of the injected fluid. Such (a) measured parameter(s) gives information on the flow of the fluid and therefore a flow characteristic, such as permeability, of the formation. Normally the flow rate is the volume/time.

The received fluid may include fluid displaced from the portion of the formation in the container and may include injected fluid.

The method may include a step of reducing, preferably substantially blocking, a fluid flowpath which is defined in use between the formation sample and the container. A plurality of different flowpaths, typically 2 or 3, may be reduced, preferably blocked.

Preferably such a flowpath is reduced, preferably blocked, at a point between the injection point and receiving point, such that when measuring the flow, the fluid cannot flow through such a flowpath from the injection point to the receiving point.

Alternatively but preferably additionally, such a flowpath between one end of the container and the closer of the points where fluid is injected or received, is reduced and preferably substantially blocked. Thus such embodiments benefit in preventing fluid escaping through such a flowpath which could affect the measurements of the flow characteristics of the sample.

Indeed the flowpaths between each end of the container and the closer of the points where fluid is injected or received respectively, may be reduced and preferably blocked.

The fluid may be oil or water and may comprise chemicals such as those used in chemical flooding. Chemical flooding uses non-Newtonian fluids for improving mobility ratios and sweep efficiencies. In chemical flooding, rheologically complex fluids such as polymer solutions, gels, foams, and other additives are injected to divert displacing fluids and to block swept zones. Alkaline (or caustic) flooding can also used for improving recovery from hydrocarbon reservoirs by increasing the pH of the injected fluids.

Typically the pressure difference between the inlet and the outlet of the container is calculated and which is indicative of the flow characteristics of the geological formation, such as the permeability.

According to a second aspect of the present invention, there is provided an apparatus for determining the flow characteristics of a geological formation, the apparatus comprising:

a container to contain a portion of the geological formation; and

a fluid injection port in the container.

Preferably the apparatus according to the second aspect of the invention is used according to the method of the first aspect of the invention. Thus the apparatus may be provided downhole, a portion of the formation may be entered into the container and fluid injected therein which typically, following measurements of certain parameters of the fluid, gives information on the flow characteristics of the formation.

Preferably the container has a fluid receiving port.

A variety of flowpaths are typically defined in use between the sample within the container and the container.

Preferably the container comprises at least one expandable member operable to reduce, preferably substantially block, such a flowpath.

A first expandable member may be provided between the fluid injection and receiving ports.

A second expandable member may be provided between one end of the container and the fluid injection or fluid receiving ports—typically whichever is closer to said end of the container, especially if said end is closer to an entrance of the container.

Certain embodiments comprise only two expandable members. Certain other embodiments contain three expandable members.

The third expandable member may be provided between the opposite end of the container and the closer of the fluid injection and receiving ports. Preferably at least one, more preferably each, of the expandable members is expandable circumferentially.

Typically the container is a core barrel, especially an inner barrel of a core barrel apparatus.

The core barrel apparatus typically also comprises an outer barrel. The outer barrel normally has a drill bit which is adapted to cut the portion of the geological formation so that this may be added into the container, typically the inner barrel.

The core barrel apparatus is normally connectable to a drill string.

Preferably the apparatus comprises a reservoir for the fluid and a pump, typically driven by an electrical motor, to pump the fluid into the container. Preferably the apparatus comprises a pressure sensor to measure the pressure at each of the fluid injection and fluid receiving ports, preferably a gauge to measure the flow rate and optionally volume of the fluid being injected and received from the container.

Preferably the apparatus comprises a data storage device such as a memory chip to store recorded data, such as on the flow rate, pressure and fluid volume. Alternatively or additionally the apparatus may comprise a means to transmit the data to the surface.

### BRIEF DESCRIPTION OF THE INVENTION

Embodiments of the present invention will now be described, by way of example only, with reference to the accompanying drawings, in which:

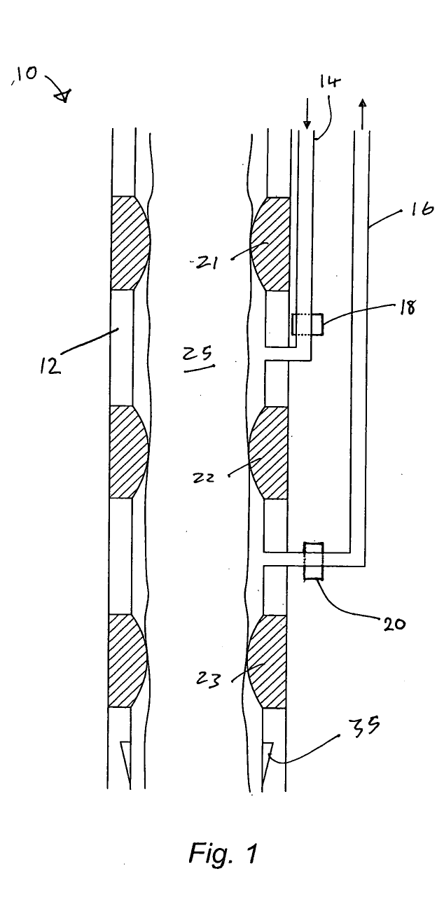

FIG. 1 is a sectional view of a coring barrel in accordance with the present invention; and,

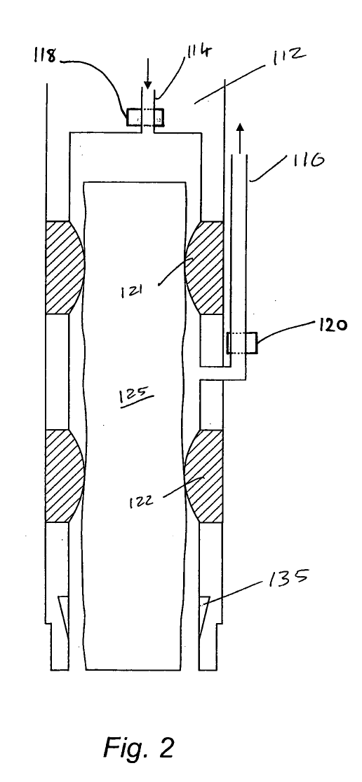

FIG. 2 is a sectional view of a second embodiment of a coring barrel in accordance with the present invention.

### DETAILED DESCRIPTION OF PREFERRED EMBODIMENTS

A coring barrel apparatus 10 is shown in FIG. 1 and comprises an inner container or barrel 12, a fluid inlet 14 and outlet 16 for injecting and receiving fluid from the inner barrel 12 respectively, and packers 21, 22, 23. The apparatus 10 also comprises a pump (not shown), an electrical motor (not shown) to drive the pump, and one or more fluid reservoirs (not shown) in communication with the fluid inlet 14. Pressure sensors (not shown) are also provided at the inlet 14 and outlet 16.

A catcher 35 is provided which pivots inwardly when the core is completely within the inner barrel 12 is also shown—the catcher 35 serves to hold the core sample within the inner barrel 12. The coring barrel also comprises a number of further components (not shown) which are conventional, such as an outer barrel, and are connected to a rotatable drill string.

The packers 21-23 are expandable members and are operable to expand further into the inner barrel 12 to block the flowpath between, in use, a core sample and the inner barrel 12, thus inhibiting fluid flow at this point.

Thus to operate the core barrel 12, a core sample is obtained in the conventional fashion—the outer barrel having a drill bit that rotates relative to the inner barrel 12 and is pushed into the geological formation by force applied to the connected drive shaft (not shown) at the surface. A core sample is cut and recovered into the inner barrel 12, as shown in FIG. 1—the core sample is referenced 25.

Before retrieving the sample 25 to the surface, a permeability test is conducted downhole. The packers 21-23 are pressurised with hydraulic fluid to inhibit and preferably block fluid flow between the core sample 25 and the core barrel 12 at three different points—packer 21 between the fluid inlet 14 and one end of the inner barrel 12, packer 22 between the fluid inlet 14 and the fluid outlet 16, and packer 23 between the fluid outlet 16 and the other end of the inner barrel 12. All fluid flow is thus directed through the core sample 25 to increase the accuracy of the permeability test.

Fluid is then injected from the reservoir by the pump into the core barrel via the inlet 14. The fluid may be any suitable fluid—such as oil, water, or surfactant. The packers 21 and 22 block fluid flow between the core barrel and the core sample, thus forcing the fluid to flow through the core sample 25. Fluid can then be recovered through the outlet 16. Packer 23 blocks fluid flow between the inner barrel and the core sample 25 below the fluid outlet 16. The amount of fluid injected may be calculated based on the number of rotations of an axis of the pump.

The volume, pressure and flow rate of fluid received at the fluid outlet 16 is measured and the data stored.

Measurement device 18 at the inlet 14 includes a pressure sensor to measure the pressure, a flow rate measurement device to measure the flow rate and a volume measurement device for measuring the volume; all of the injected fluid. Measurement device 20 at the outlet 16 includes a pressure sensor to measure the pressure, a flow rate measurement device to measure the flow rate and a volume measurement device for measuring the volume; all of the received fluid.

The coring barrel apparatus can then be recovered to the surface. At the surface the data can be retrieved from the apparatus by conventional means and the volume, pressure and flow rate of the fluid at the inlet 14 can be compared to that at the outlet 16, thus providing in situ measurements on the flow characteristics of the sample. The permeability may be calculated by application of Darcy's law−Permeability=[Flow rate×Viscosity×Length]/[Surface×(Inlet Pressure−Outlet Pressure)].

The core sample taken will normally undergo further analysis for a variety of other parameters generally known as core analysis.

A second embodiment of a core barrel 110 in accordance with the present invention is shown in FIG. 2. A coring barrel 110 comprises the same features as the first embodiment and like parts are preceded by a ‘1’ and not described further.

One difference with the second embodiment in that it contains only two packers 121, 122. An inlet 114 is provided at one end of the core barrel. Thus a third packer is not required. The second embodiment functions in the same way as that described for the first embodiment.

Embodiments of the present invention can be used to measure the permeability for fluid production evaluation. The permeability measurements can also be useful for viability analysis for enhanced oil recovery (EOR) processes. Further applications of the present invention are in petrophysics—where permeability, porosity and data are useful and production technology where rock fluid compatibility and control parameters are important.

Improvements and modifications may be made without departing from the scope of the invention. For example, a fluid outlet line may not be provided for certain embodiments; the flow rate and pressure required to inject the fluid can be used to indicate the flow characteristics of the core sample.

I claim:

1. Method for determining the flow characteristics of a geological formation, the method comprising the steps of:
providing a container within the formation;
adding a portion of the formation to the container;
and while the container remains in the formation:
injecting fluid into the container such that a portion of the fluid flows through said portion of the formation; and
measuring the flow of the injected fluid.

2. Method of claim 1, wherein the step of measuring the flow of the injected fluid includes measuring at least one of the flow rate, pressure and volume of the injected fluid.

3. Method of claim 1, receiving a portion of fluid from the container and at least one of the following parameters of the received fluid is measured: volume, flow rate, pressure.

4. Method of claim 1, wherein at least one flowpath is defined between the portion of the formation in the container and the container; the method including a step of constricting the at least one fluid flowpath.

5. Method of claim 4, comprising constricting the at least one flowpath at a point between an injection point for injecting the fluid and a receiving point for receiving fluid.

6. Method of claim 4, comprising constricting the at least one flowpath at a point between one end of the container and the closer of an injection point for injecting the fluid and a receiving point for receiving fluid.

7. Method of claim 6, comprising constricting the at least one flowpath between the opposite end of the container and the other of the injection point for injecting fluid and the receiving point for receiving fluid.

8. Apparatus for determining the flow characteristics of a geological formation, the apparatus comprising:
a container to contain a portion of the geological formation; and
a fluid injection port in the container.

9. Apparatus of claim 8, wherein the container comprises at least one expandable member, the expandable member operable to constrict a flowpath defined in use between the portion of the formation in the container and the container.

10. Apparatus of claim 8, wherein the container has a fluid receiving port.

11. Apparatus of claim 9, wherein the container has a fluid receiving port and wherein the expandable member is provided between the fluid injection port and the fluid receiving port.

12. Apparatus of claim 10, wherein an/the expandable member is provided between one end of the container and the closer of the fluid injection port and fluid receiving port.

13. Apparatus of claim 10, wherein three expandable members are provided, the first is provided between the fluid injection port and fluid receiving port; the second is provided between one end of the container and the closer of the fluid injection port and fluid receiving port; the third is provided between the opposite end of the container and the other of the fluid injection port and fluid receiving port.

14. Apparatus of claim 8, wherein the apparatus also comprises at least one of a pressure sensor to measure the pressure, a flow rate measurement device to measure the flow rate and a volume measurement device for measuring the volume; all of the injected fluid.

15. Apparatus of claim 8, wherein the apparatus also comprises at least one of a pressure sensor to measure the pressure, a flow rate measurement device to measure the flow rate and a volume measurement device for measuring the volume; all of the received fluid.
